(19) United States
(12) Patent Application Publication
(10) Pub. No.: US 2024/0330298 A1
(43) Pub. Date: Oct. 3, 2024

(54) GROUPING CONTACTS USING TIERED WAREHOUSE LEVELS

(71) Applicant: Twilio Inc., San Francisco, CA (US)

(72) Inventors: Anand Jha, Newark, CA (US); Fan Lu, Denver, CO (US); Anurag Sethi, San Carlos, CA (US)

(21) Appl. No.: 18/191,359

(22) Filed: Mar. 28, 2023

(51) Int. Cl. G06F 16/2455; G06F 11/34; G06F 16/2453; G06F 16/28

(52) U.S. Cl. CPC G06F 16/24552; G06F 11/3419; G06F 16/24549; G06F 16/283

(57) ABSTRACT

Described herein are techniques for deploying a plurality of data processing pipelines to execute contact grouping queries to upload contact data into contact records of contact group tables in a cloud-based, virtual data warehouse. Each contact grouping query is assigned to a data pipeline of a plurality of data pipelines based on characteristics of the contact grouping query and the count of contact records associated with the entity on whose behalf the contact records are being maintained. Additionally, the execution runtime is obtained for each contact grouping query so that an average execution runtime for the contact grouping query can be cached. An expected execution runtime of all contact grouping queries allocated to a specific data pipeline can then be calculated and used in determining whether additional data pipelines may be necessary to meet a service level objective that indicates a time interval during which a contact grouping query is to be executed.

### TECHNICAL FIELD

The present application generally relates to a scalable technique for deploying multiple data processing pipelines to efficiently and cost effectively execute contact grouping queries to load data (e.g., contact data) into tables of a virtual data warehouse having tiered warehouse levels. More specifically, the present application describes a data processing pipeline architecture that intelligently allocates the execution of contact grouping queries to data processing pipelines that are configured to invoke warehouses, of a virtual data warehouse service, with sufficient compute resources to execute a plurality of contact grouping queries in a time period that will satisfy a time interval indicated in a service level objective (“SLO”).

### BACKGROUND

A data warehouse is an enterprise system used for the analysis and reporting of structured and semi-structured data from multiple data sources, such as point-of-sale transactions, marketing campaign automations, customer relationship management, and more. A data warehouse can store both current and historical data in one place and is designed to give a long-range view of data over time, making it a primary component of business intelligence applications. However, before data in a data warehouse can be leveraged for the benefit of the enterprise, the data must be written to and stored in the data warehouse. In many situations, particularly situations in which large amounts of data are being generated rapidly and the data need to be written to tables in the data warehouse in a timely manner, this can be technically challenging.

### BRIEF DESCRIPTION OF THE DRAWINGS

Embodiments of the present invention are illustrated by way of example and not limitation in the figures of the accompanying drawings, in which:

FIG. 1 is a diagram illustrating an example of how a cloud-based, virtual data warehouse service may provide tiered warehouse levels, consistent with embodiments of the present invention.

FIG. 2 is a diagram illustrating an example of a database table storing contact records, including contact records from which groups of contacts can be established for purposes of identifying a target audience for a marketing campaign automation, consistent with embodiments of the invention.

FIG. 3 is a diagram illustrating an example of a customer data platform that is integrated with a contact management service and a messaging service, and with which a data pipeline infrastructure, consistent with embodiments of the present invention, may be integrated and deployed.

FIG. 4 is a diagram illustrating an example of an individual data processing pipeline for loading data into a table of a data warehouse, consistent with embodiments of the present invention.

FIG. 5 is a diagram illustrating an example of a data processing pipeline architecture, consistent with embodiments of the present invention.

FIG. 6 is an example of a computer system with which any of the methodologies described herein may be implemented.

FIG. 7 is a diagram illustrating an example a software architecture or framework, which may be used in implementing any of the various systems and methodologies described herein.

### DETAILED DESCRIPTION

Described herein is a technique for deploying multiple data pipelines to efficiently and cost effectively execute contact grouping queries to load data (e.g., contact data) into tables of a cloud-based, virtual data warehouse service having tiered warehouse levels. In the following description, for purposes of explanation, numerous specific details and features are set forth in order to provide a thorough understanding of the various aspects of different embodiments of the present invention. It will be evident, however, to one skilled in the art, that the present invention may be practiced and/or implemented with varying combinations of the many details and features presented herein.

The mechanism by which data is loaded into tables of a cloud-based, virtual data warehouse is generally referred to as a data pipeline, or data processing pipeline. A data pipeline typically involves a number of data processing tasks, performed serially, during which data is read from a source location, transformed and optimized, and then written to appropriate tables of a data warehouse. In many situations, particularly situations in which large amounts of data are being generated rapidly and the data need to be written to tables in the data warehouse in a timely manner, implementing an efficient and cost-effective data pipeline is technically challenging.

As one example, consider an application or service that provides marketing campaign automations-sometimes referred to as automated marketing campaigns or automated messaging campaigns. A marketing campaign automation is a collection of messages (e.g., email, SMS, text message, instant messages, etc.) that are configured to be delivered to a target audience, in a specified order, over a duration of time. Typically, a marketing campaign automation will specify a particular amount of time that should lapse between the sending of individual messages to a contact. Often, the one or more messages share a common theme or objective. For example, a marketing campaign automation may be established to welcome new end-users to a web-based service after each end-user initially registers with the web-based service. As such, each message may provide information that introduces the new end-user to a different aspect or feature of the web-based service, with the ultimate objective of encouraging new end-user engagement with the web-based service. In yet another example, a promotional marketing campaign automation may be established to promote a new product, feature or service. A marketing campaign automation may be established to encourage an end-user to connect with an enterprise via one or more social networking channels. A marketing campaign automation-sometimes referred to as a “post purchase” campaign—may be established to send messages to customers who have recently made a purchase. Accordingly, one message in the marketing campaign may promote products that are complimentary to the one previously purchased. Another message in the marketing campaign automation may encourage the customer to provide a web-based review of the product or service that was purchased. Of course, many other types of messaging campaign automations are possible.

To be effective, the messages that are sent as part of a marketing campaign automation should have content that is highly relevant and timely delivered to the message recipient. To that end, many marketing campaign systems provide for the ability to group contacts stored in a contacts database by common characteristics-a concept referred to herein as contact grouping. Grouping contacts by common characteristics allows for creating content that is highly tailored to specific groups of contacts. For example, a contact grouping query may create a group of contacts by selecting from all contact records in a contacts table for a specific entity, those contact records having specific characteristics as determined by values in specific data fields of each contact record. By way of example, a contact grouping query may create a group of contacts for customers of a company (e.g., the entity) who are female, living in a specific city (e.g., Chicago) or state (e.g., Illinois), and who have not logged in to a web-based service in the last 30 days.

Of course, creating effective groups of contacts for a marketing campaign automation depends on having both a sufficient quantity and quality of contact data. Some marketing campaign systems integrate with a customer data platform to generate robust customer profiles and contact data for customers. A customer data platform (“CDP”) is a software-based service-typically offered to enterprise customers in a software-as-a-service (“SaaS”) or platform-as-a-service (“PaaS”) model-which is used to obtain, aggregate and organize customer data across a wide variety of customer touchpoints. By way of example, a CDP may integrate with a variety of customer touchpoints including websites, mobile applications, point-of-sale systems, and many others. Each touchpoint is a data source that is configured to communicate customer data and customer event data to the CDP where it is processed and ultimately associated with a customer profile of a customer, and potentially added to a contact record for the customer. Accordingly, this customer data and customer event data can then be used to generate groups of contacts sharing in common certain characteristics.

The nature of the data obtained through a CDP allows for generating groups of contacts at a rather granular level. For instance, by including in a contact record one or more custom data fields for specific customer event data obtained through the CDP, a contact grouping query can be defined to select contact records for contacts who have purchased specific products, installed specific mobile applications on their mobile devices, and/or selected a specific button or other user interface element presented on a web page. Of course, when a specific enterprise has a large number of contacts, and thus a large number of contact records, an extremely large amount of contact data can be generated in a short amount of time. Furthermore, given the granularity of the data that can be obtained via the CDP, contact grouping queries that are used to group the contact records and write the contact data to tables in a data warehouse may be complex, requiring significant computing resources to process in a timely manner.

A marketing campaign automation may be defined such that a second message is to be communicated to a contact in a specific group, one hour after sending the same contact a first message, but only if the contact did not open and view the first message. Accordingly, if the contact did indeed open and view the first message, the event data indicating this action by the contact will be received at the CDP and communicated to a contact management service so that the appropriate contact record can be updated. Based on the update to the contact record, the contact record may be added to, or removed from, a table stored in a virtual data warehouse. This process of updating the tables in the data warehouse to reflect changes in the contact records is typically performed as part of a scheduled, data processing pipeline. However, if for any reason there are delays in updating the contact data in the tables of the data warehouse, a marketing campaign automation may be negatively impacted. For instance, in the example set forth above, a second message may be communicated to a contact even when that contact previously opened and viewed the first message—causing confusion for the message recipient. Therefore, in many instances, an entity providing a messaging service that has marketing campaign automations will offer a service level objective (“SLO”) defining the time interval between which contact data will be updated in the tables of a virtual data warehouse.

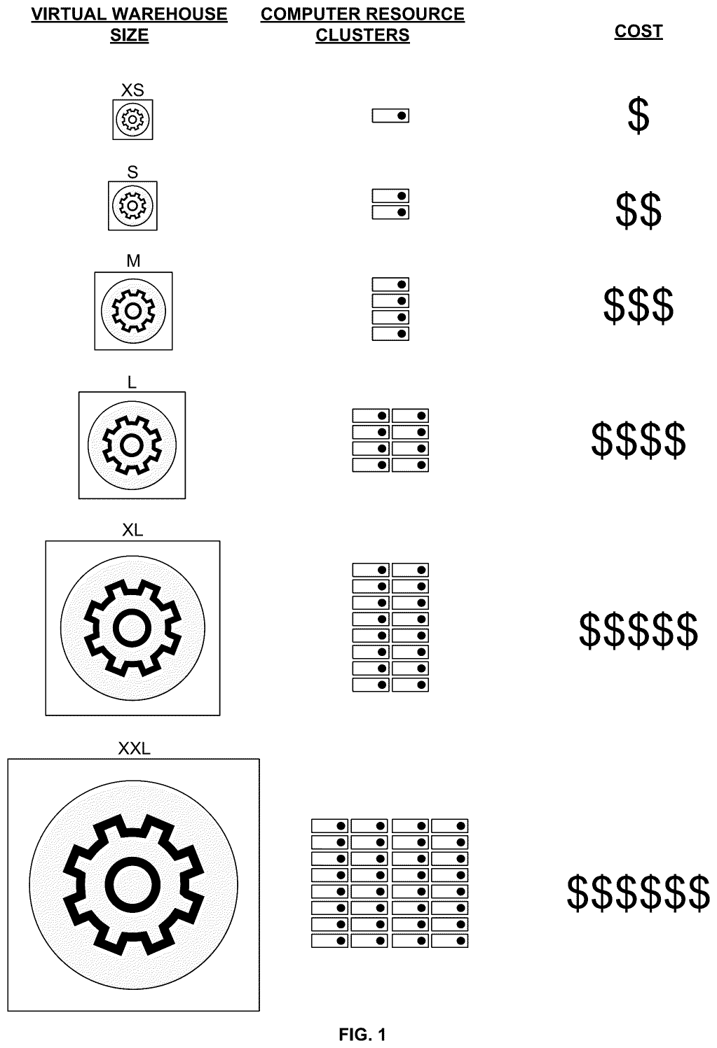

To further complicate the issue, some data warehouse service providers, such as Snowflake®, separate compute resources from storage services, and provide data warehouses in a tired service level offering, where the compute resources (and cost) differ by tier. For example, as illustrated in FIG. 1, when a warehouse is utilized in a data pipeline to execute a query (e.g., a contact grouping query), perform data manipulation language (“DML”) tasks, and load data into tables (e.g., contact group tables), the warehouse can be invoked in one of several sizes (e.g., extra-small (“XS”), small (“S”), medium (“M”), large (“L”), extra-large (“XL”) or double extra-large (“XXL”). The size of the warehouse that is invoked impacts the number of virtual compute resources that are dedicated to processing tasks associated with the data pipeline that is executing queries and loading data into the tables of the virtual data warehouse. For instance, as shown in FIG. 1, an extra-small warehouse is associated with a single compute resource. In the example illustrated in FIG. 1, each increase in size (e.g., from extra-small to small) of warehouse results in a doubling of the compute resources allocated for data processing tasks. Furthermore, as shown in FIG. 1, with each increase in warehouse size, there is a corresponding increase in the cost. Note, the increasing cost with each increase in data warehouse size may not be linear, as suggested in FIG. 1.

In the context of a messaging system or service that provides marketing campaign automations, each customer or entity, as an end-user of the messaging system or service, may have multiple marketing campaign automations executing at any given moment in time. Each marketing campaign automation may have multiple contact group tables and associated contact grouping queries, for example, to specify a target audience for the marketing campaign, to group contacts who may have exited a target audience for a marketing campaign, and so forth. Typically, the contact grouping queries for several customers of the messaging system are queued together for processing with a data pipeline according to a predefined schedule, such that each customer's tables are updated in a reasonable amount of time using a single data warehouse of a set size (e.g., small or medium). However, problems arise when a particular customer of the messaging system has a significant number of contacts or is using one or more complex contact grouping queries to generate groups of contacts (e.g., stored in tables). The number of contacts and the complexity of the contact grouping query are two factors that slow down the execution of a contact grouping query, which may ultimately force other contact grouping queries assigned to the data processing pipeline to wait until all prior contact grouping queries have successfully been completed. This means that some customers of the messaging system, particularly customers who may have a large number of contacts (and thus, contact records), may extend the time needed to update all contact records that should be part of a contact group, and thus written to a contact group table. This may ultimately lead to a violation of an SLO promised to a customer by the entity operating the messaging system or service.

Consistent with embodiments of the present invention, to scale the contact grouping query processing and to satisfy an SLO for customers having varying numbers of contacts (and thus, contact records), and varying levels of contact grouping query complexity, multiple data pipelines are established, with each data pipeline configured to invoke a warehouse of a specific size, based on various characteristics of the customer, the contact records and the contact grouping query. Specifically, consistent with some embodiments, non-paying customers of the messaging system or service—that is, customers who may be using a free version of the messaging system or service—will have their contact grouping queries assigned in a round-robin manner to one of a predetermined number of data pipelines configured to invoke a warehouse of a specific size (e.g., small or extra-small), thereby reducing costs to the enterprise that is operating the messaging system or service. For paying customers of the messaging system or service, to scale the contact grouping query processing tasks for a larger number of contacts and varying contact grouping query complexities, additional pipelines and warehouses will be deployed to uphold the SLO for processing all contact groups within some predefined interval of time (e.g., one hour). In general, the execution of each contact grouping query will be allocated to a data pipeline that is configured to invoke a warehouse of a specific size, based at least in part, on a count of the total contact records associated with the customer—that is, the entity on whose behalf the contact records are being maintained.

In addition, each contact grouping query may be classified by type—simple or complex. The classification of the contact grouping query may be based on the SQL statements used in the contact grouping query, or other characteristics of the contact grouping query. Consistent with some embodiments, any contact grouping query that includes one or more SQL JOIN statements will be classified as having a contact grouping query type of complex, whereas any contact grouping query that does not include a SQL JOIN statement will be classified as having a contact grouping query type of simple. A SQL JOIN statement may be included in a contact grouping query, for example, when the contact grouping query is referencing contact data in a contacts table along with associated event data in a separate event table. With some embodiments, a contact grouping query may be characterized as complex, when the contact grouping query is time based. For example, a time-based contact grouping query may reference data records that were updated in a specified time period. By way of example, it may be desirable to identify a group of contacts who took some specific action within a recent time period (e.g., the last seven hours, or the last three days, etc.) With some embodiments, the contact grouping query classification (e.g., simple or complex) may be based on a contact grouping query referencing some predetermined minimum number of custom fields of a data record. Accordingly, with some embodiments, the executing of each contact grouping query will be allocated to a data pipeline that is configured to invoke a data warehouse of a specific predetermined size, based on a combination of the total count of contact records assigned to the entity (e.g., the customer) and the contact grouping query type or classification.

Each time a contact grouping query is processed, the query execution runtime for the contact grouping query will be obtained and stored in a cache. Here, the execution runtime refers to the duration of time that was necessary to complete the execution or processing of the query. For each contact grouping query, the cache will store the query execution runtime for each of some predetermined number (e.g., five) of prior contact grouping query executions. In addition to storing in the cache individual query execution runtimes, an average query execution runtime for the contact grouping query is calculated and stored in the cache. For instance, the average query execution runtime for a contact grouping query may be derived for whatever number of prior contact grouping query execution runtimes are stored in the cache. Accordingly, each time a contact grouping query is to be executed, the contact grouping query can be allocated to an optimal data pipeline, based on the average execution runtime of the contact grouping query, for some predefined number (e.g., five) of prior query executions.

With some embodiments, a query execution runtime of a prior query execution, or the average query execution time may be used to override a contact grouping query's default allocation or mapping to a data pipeline. For instance, if a particular contact grouping query is assigned to a data pipeline that invokes a specific sized warehouse, but the average query execution runtime for the query is significantly greater than some threshold, the contact grouping query may be dynamically reallocated to a data pipeline that invokes a larger warehouse, to ensure that the contact grouping query can be processed in a timely manner without negatively impacting the processing of other contact grouping queries. The threshold may be based on some statistic calculated with respect to all or some subset of similar contact grouping queries, such as the contact grouping queries that are allocated to the same data pipeline (and thus, the same sized data warehouse).

By mapping the execution or processing of contact grouping queries to specific data pipelines configured to invoke warehouses of a specific size based on characteristics of the customer and the contact grouping query, and by caching query execution runtimes, the processing of contact grouping queries can be done in a cost-effective way while ensuring that each contact grouping query is processed in a timely manner-specifically, in an amount of time that satisfies any time interval set forth in an SLO promised by the entity operating the messaging service. Furthermore, the techniques described herein provide a scalable solution. For example, as the number of contact records for any one customer grows, the contact grouping queries of that customer will automatically be reallocated to a data pipeline with an appropriate warehouse size to timely execute the contact grouping queries. Furthermore, as the total number of customers increases, and thus the number of contact grouping queries that need to be executed increases, additional data pipelines can be added to easily handle the increased workload. Other aspects and advantages of the innovative subject matter will be readily apparent from the description of the several figures that follows.

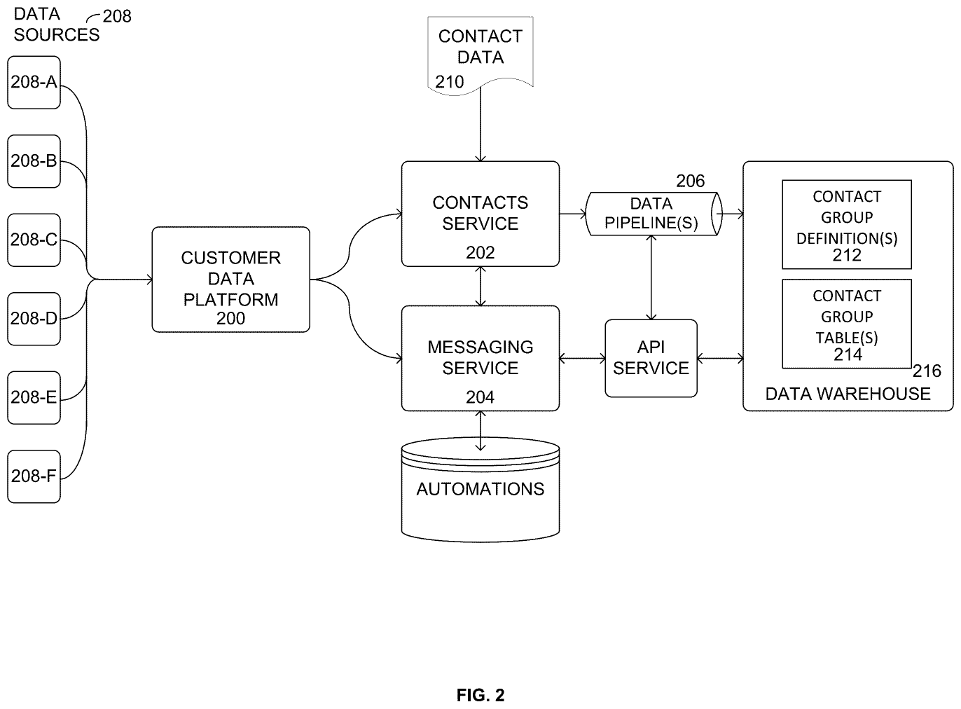

FIG. 2 is a diagram illustrating an example of a customer data platform 200 that is integrated with a contacts service 202 and a messaging service 204, and with which a data processing pipeline infrastructure 206, consistent with embodiments of the present invention, may be integrated and deployed. The customer data platform (“CDP”) may be offered to customers (e.g., end-users of the CDP, or end-users of the contacts service 202 and/or the messaging service 204) via a software-as-a-service model, or via a platform-as-a-service model. Here, the term “customer” refers to a customer of the entity or organization that is operating and offering the CDP as a service. Each customer of the CDP will have its own individual customers who interact with the various data sources 208, thereby creating customer data and customer event data—for the end-user of the CDP—that is received and processed at the CDP. For example, each customer, as an end-user of the CDP 200, will configure various data sources (e.g., one or more websites 208-A, mobile applications 208-B, cloud-based applications 208-C, telephony services 208-D, point-of-sale systems 208-E, e-commerce shopping carts 208-F, and many others) to communicate data to the CDP 200 in response to detecting various customer interactions. Typically, the various data sources 208 are integrated to operate with the CDP 200 by leveraging an application programming interface (“API”) provided by the entity operating the CDP 200. As customer data and customer event data are received by the CDP, certain data may be forwarded to the contacts service 202, where the data may be added to an existing contact record. For example, in specific instances where customer data or customer event data are associated with a customer known to have an existing contact record managed by the contacts service, certain data relating to that customer may be forwarded to the contact service 202 so that the corresponding contact record can be updated.

Consistent with some embodiments, the contact service 202 may allow an end-user to batch update contact records, or otherwise integrate with one or more data sources for contact information. For instance, the contacts service 202 may allow an end-user to upload, or otherwise create contact records for contacts, which may then be leveraged by the messaging service 204. For example, an end-user of the contacts service 202 may create a web-based form to prompt customers for contact information. Alternatively, an end-user of the contacts service 202 may upload lists of contact records 210 from existing data sources (e.g., spreadsheets, database tables, etc.) Consistent with some embodiments, some contact records may include a number of reserved data fields (e.g., first name, last name, email address, telephone number, etc.), which may be used to link contact records with customer profile records (not shown) maintained by the CDP. Although shown in FIG. 2 as distinct services, with some alternative embodiments, the contacts service 202 and the marketing campaign service 204 may be one unified service, such that the contacts service is a sub-component of the messaging service.

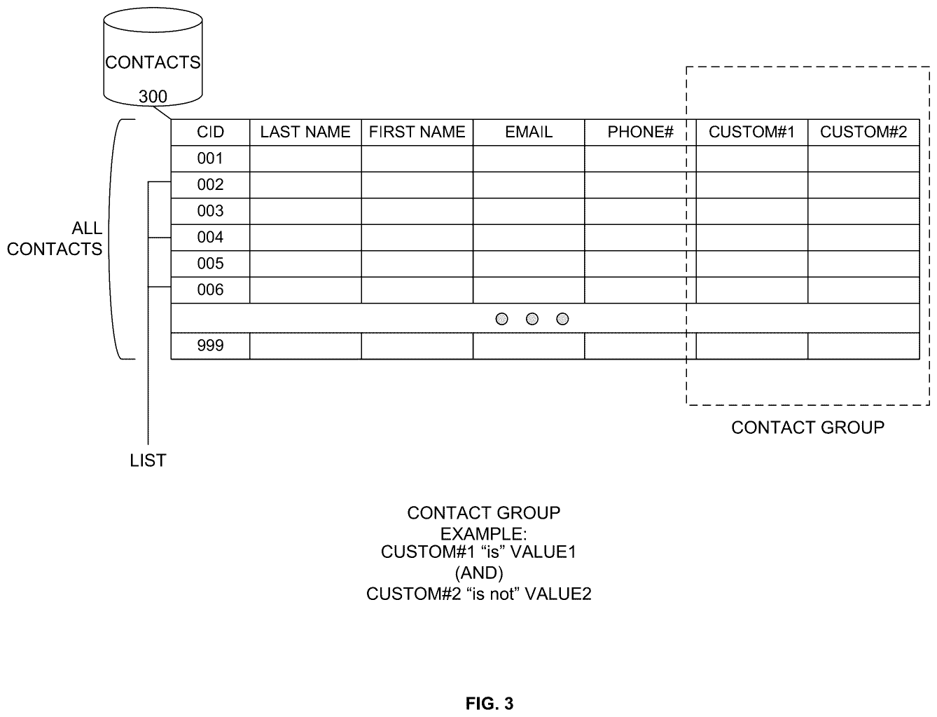

FIG. 3 is a diagram illustrating an example of a contacts database 300 from which a target audience for an automated marketing campaign may be selected or defined, by creating a contact grouping query. As part of defining the various parameters for an automated marketing campaign, an end-user will specify one or more conditional statements, from which a contact grouping query is created, and which ultimately defines or creates a target audience to receive messages. By specifying one or more conditional statements, a contact grouping query can be executed against some set of contact records for a customer. The contact grouping query is based on a conditional statement, or a combination of conditional statements joined by a logical operator (e.g., AND or OR), and representing the desired characteristics (e.g., the entry criteria) of the target audience. By way of example, a target audience for a marketing campaign may be defined as a group of contacts (e.g., contact records stored in a table), where each contact in the group has a contact record indicating that the contact is a female, living in the city of Chicago, and has not logged into a web-based service in the last thirty days.

As new contact records are generated, and contact records are updated over time as an automated marketing campaign is in an active state, new contact records may enter the group defined as the target audience, and existing contacts may exit the group defined as the target audience. For instance, if a customer having a contact record in the group that is defined for the target audience updates his or her address to reflect a new city of residence (other than Chicago), the contact record for that customer will exit the group of contacts that defines the target audience, when the contact grouping query is executed to update the corresponding table. Similarly, if a contact record is updated to reflect that a customer has recently relocated to the city of Chicago, when the contact group tables are updated, the contact record for that customer may be added to the target audience, and thus the automated marketing campaign may be invoked for that customer.

By way of example and as shown in FIG. 3, each individual contact record in the contacts database has or is otherwise associated with two separate custom data fields-“CUSTOM #1,” and “CUSTOM #2.” These are data fields that may be added by the end-user, that is, the marketer who is creating the automated marketing campaigns. A group of contacts may be defined by specifying a condition with reference to any of the data fields in a contact record, and specifically, with reference to one or more custom data fields. For instance, in the example of FIG. 3, a dynamic subset of contacts may be defined by the contact group satisfying the conditional statement, “CUSTOM #1=VALUE (AND) CUSTOM #2 !=VALUE.” As such, any contact associated with a contact record that has data in the data fields (e.g., CUSTOM #1 AND CUSTOM #2) satisfying the conditional statement established by the selected operator and value for the conditional statement, will be included in the contact group.

Although not shown in FIG. 3, a contact grouping query may reference contact records stored in one table, and event data stored in a separate event table. Accordingly, as customers interact with various data sources, generating both customer data and customer event data, the customer event data may flow through the CDP to an event table. Consequently, some contact groups may include SQL JOIN statements to create contact records in a contact group table that include data joined from separate tables.

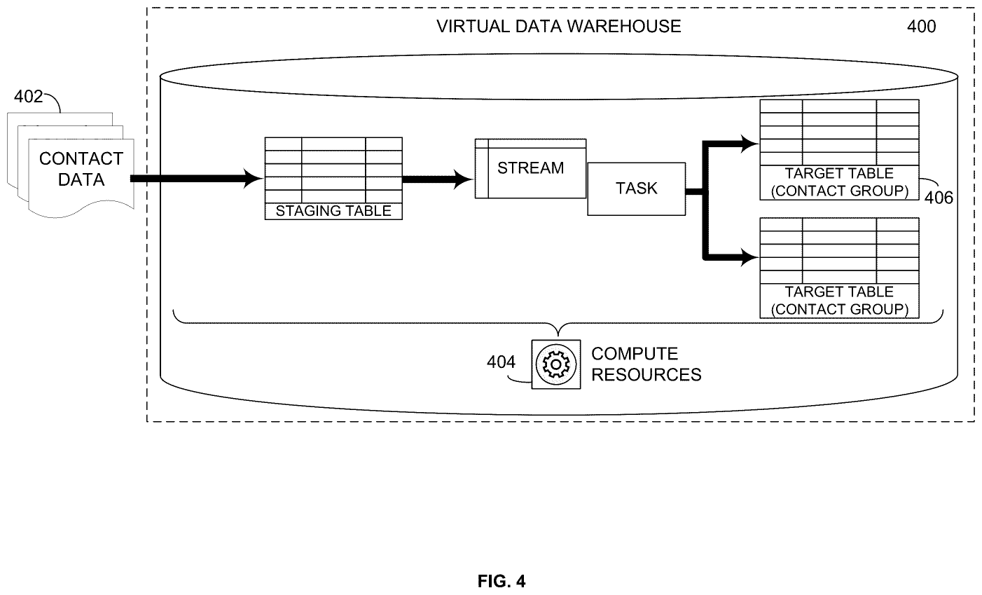

FIG. 4 is a diagram illustrating an example of a single data processing pipeline for loading data into a virtual data warehouse 400, consistent with embodiments of the present invention. Consistent with some embodiments, one or more data pipelines may be implemented to update contact grouping queries or contact group definitions on an ad-hoc basis, while several data pipelines may be configured to execute contact grouping queries to update contact group tables—that is, to add new contact records to contact group tables and to update existing contact records with new data. There are a variety of techniques with which a data pipeline may be implemented, consistent with embodiments of the invention. As a general matter, a data pipeline may be invoked according to a schedule, or the data pipeline may be invoked by a triggering event. As shown in FIG. 4, over time, contact data 402 for various contact records of each entity (e.g., each customer or end-user of the messaging service) are added to a contacts database. The contact data 402 may also be written to a temporary storage location—e.g., an Amazon® S3 bucket, or a file. Typically, when preparing the contact data for loading into the data warehouse, the data may be separated by entity, and otherwise manipulated or formatted for further processing by the next stage in the pipeline.

As illustrated in FIG. 4, when the contact data 402 is ready to be loaded into a table, a scheduled task will invoke a preconfigured data warehouse 404 of a set size to process the corresponding contact grouping query that will select the relevant data to be written to the appropriate table. Accordingly, the data pipeline to which the contact grouping query is allocated or assigned will result in a data warehouse of a particular size being invoked to execute or process the query. As shown in FIG. 4, the size of the data warehouse that is invoked by the pipeline will ultimately determine the number of compute resources 404 that are spun up to execute the processing of the contact grouping query and to write the contact data to the appropriate table 406.

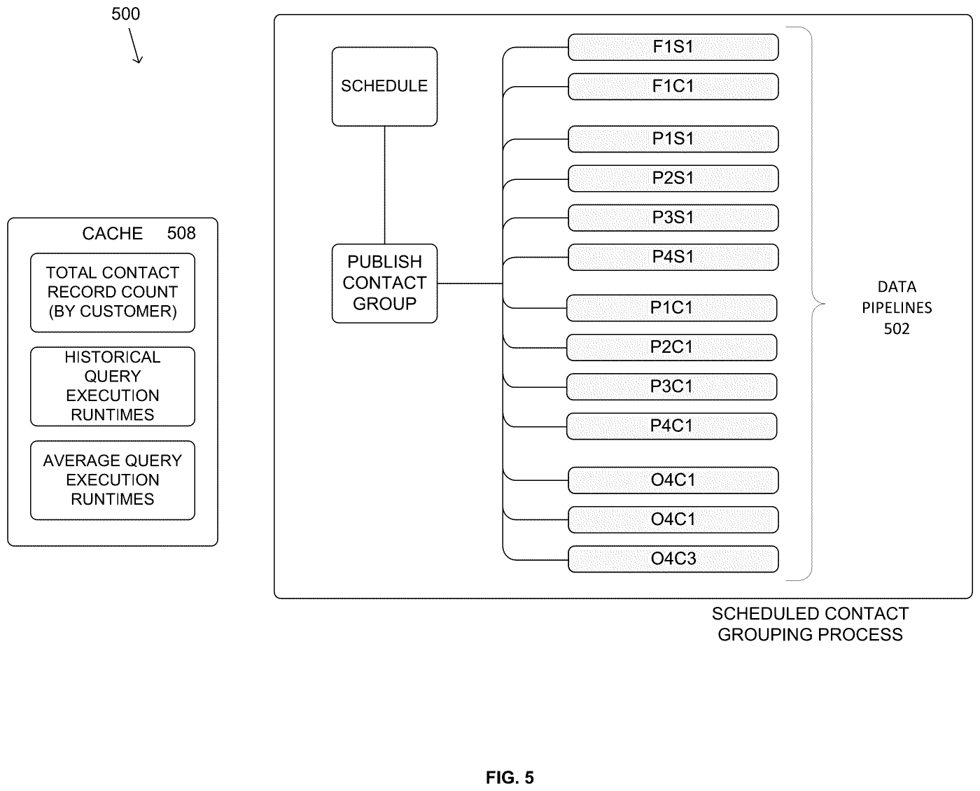

FIG. 5 is a diagram illustrating an example of a data processing pipeline architecture 500, consistent with some embodiments of the present invention. As illustrated in FIG. 5, consistent with some embodiments, a number of data pipelines 502 are preconfigured to invoke a data warehouse of a specific size. For instance, each of the several data pipelines shown in FIG. 5 is configured to invoke a data warehouse of the virtual data warehouse service having a specific size, thus, impacting the number of compute resources used to execute or process each contact grouping query allocated to the data pipeline. The contact grouping queries are allocated to the various data pipelines based on characteristics of the customer and the contact grouping query. Specifically, the data pipeline to which the execution or processing of a contact grouping query is allocated may depend on whether the customer is a paying customer, or alternatively, whether the customer is using a free version of the messaging service. Additionally, each contact grouping query may be classified, such that the contact grouping query type is also considered in allocating the contact grouping query to a data pipeline. For example, some contact grouping queries use certain SQL statements that make the contact grouping query more complex than others, impacting the query execution runtime. Some queries are more complex because they may be time-based, or reference a number of custom fields. Finally, the total count of contact records for the customer is considered when allocating a contact grouping query to a data pipeline. For example, the more contact records that a customer has, the longer it may take to process a contact grouping query. Thus, as a general matter, customers with relatively higher total contact record counts will have their contact grouping queries assigned to data pipelines that are configured to invoke larger data warehouses with more compute resources, to ensure that the contact grouping queries can be processed in a timely manner.

The several tables below provide an example of how the various customer and query characteristics are used, in one embodiment, to allocate contact grouping queries to data pipelines configured to invoke data warehouses of different sizes. In the table immediately below, the first column indicates whether the customer is using a free plan type, or a paid plan type. The second column indicates a range of contact records. The third column specifies a tier designation. Accordingly, if a customer is a non-paying customer (e.g., a free plan), regardless of the number of contact records that customer has, the customer's contact grouping queries will be allocated to a data pipeline designated as tier “F1.” In this tier, the data pipeline is configured to invoke a warehouse having a size of extra-small or small. As indicated in the “CONACT COUNT THRESHOLDS” table below, a paying customer with less than one million (“<1M”) contact records will have contact grouping queries allocated to a data pipeline designated as tier “P1” where “P” designates the plan type (“Paid”) and “1” indicates a tier level. At this tier (e.g., “P1”), the data pipelines to which the contact grouping queries are allocated will invoke a warehouse having a size of small.

CONTACT COUNT THRESHOLDS

| User Plan Type | Number of contacts | Tier | Details |
|---|---|---|---|
| Free | N/A | F1 | All contact groups from |
| | | | unpaid users will be |
| | | | routed to an x-small or |
| | | | small sized warehouse |
| Paid | <1M | P1 | Paid users will have |
| | | | their contact groups |
| | | | processed by a small |
| | | | sized warehouse |
| Paid | >1M and <=5M | P2 | Paid users will have |
| | | | their contact groups |
| | | | processed by a medium |
| | | | sized warehouse |
| Paid | >5M and <=10M | P3 | Paid users will have |
| | | | their contact groups |
| | | | processed by a |
| | | | large sized warehouse |
| Paid | >10M | P4 | Paid users will have |
| | | | their contact groups |
| | | | processed by a 2x-large |
| | | | sized warehouse |

In the “QUERY TYPES” table set forth below, the query type designations are illustrated. By way of example, a simple query is a query that uses only standard filters on contact data (e.g., no SQL JOIN statements). A complex query is a contact grouping query that filters contact data and/or event data using one or more SQL JOIN statements.

QUERY TYPES

| Contact Grouping | | |
|---|---|---|
| Query Type | Tier | Description |
| simple | 1 | A standard query using filters |
| | | on contact data only |
| complex | 2 | A query that filters based on |
| | | contact data and/or event |
| | | data using one or more JOINs |

In the “PIPELINE ALLOCATION SCHEME” table set forth immediately below, an example of a contact grouping query to data pipeline mapping scheme is presented. In the first column, a pipeline identifier (“ID”) is shown. The pipeline IDs correspond with the data pipelines 500 illustrated in FIG. 5. The second column specifies a warehouse name that is used by the data pipeline to invoke the appropriate warehouse in the virtual data warehouse service. The third column specifies the warehouse size that will be invoked by referencing the warehouse name, as preconfigured. As indicated in the first row of the table below, the pipeline ID, “F1S1” indicates that the data pipeline with warehouse name “GROUP_SCHEDULED_PROCESS_F1S1_PRODUCTION” will invoke a warehouse of size extra-small (e.g., “X-Small”) to process contact grouping queries for customers using a free plan (e.g., “F1”) with contact grouping queries that are classified as simple “S.” The additional number “1” following the “F1S” in the pipeline ID indicates the data pipeline number if there are more than one data pipelines at this level.

PIPELINE ALLOCATION SCHEME

| PIPELINE | WAREHOUSE | WAREHOUSE | |
|---|---|---|---|
| ID | NAME | SIZE | Notes |
| F1S1 | GROUP_SCHEDULED_PROCESS_F1S1_PRODUCTION | X-Small | Process contact groups |
| (Free 1 Simple 1) | | | for free users |
| F1C1 | GROUP_SCHEDULED_PROCESS_F1C1_PRODUCTION | Small | Process contact groups |
| (Free 1 Complex 1) | | | for free users |
| P1S1 | GROUP_SCHEDULED_PROCESS_P1S1_PRODUCTION | X-Small | Used for processing simple |
| (Paid 1 Simple 1) | | | contact groups but user has |
| | | | less than 1M contacts |
| P1S2 | GROUP_SCHEDULED_PROCESS_P1S2_PRODUCTION | X-Small | Used for processing simple |
| (Paid 1 Simple 2) | | | contact groups but user has |
| | | | less than 1M contacts |
| P2S1 | GROUP_SCHEDULED_PROCESS_P2S1_PRODUCTION | Small | Used for processing simple |
| (Paid 2 Simple 1) | | | contact groups but user has |
| | | | between 1-5M contacts |
| P3S1 | GROUP_SCHEDULED_PROCESS_P3S1_PRODUCTION | Medium | Used for processing simple |
| (Paid 3 Simple 1) | | | contact groups but user has |
| | | | between 5-10M contacts |
| P4S1 | GROUP_SCHEDULED_PROCESS_P4S1_PRODUCTION | Large | Used for processing simple |
| (Paid 4 Simple 1) | | | contact groups but user has |
| | | | over 10M contacts |
| P1C1 | GROUP_SCHEDULED_PROCESS_P1C1_PRODUCTION | Small | Used for processing |
| (Paid 1 Complex 1) | | | complex contact groups but |
| | | | user has less than 1M |
| | | | contacts |
| P2C1 | GROUP_SCHEDULED_PROCESS_P2C1_PRODUCTION | Medium | Used for processing |
| (Paid 2 Complex 1) | | | complex contact groups but |
| | | | user has between 1-5M |
| | | | contacts |
| P3C1 | GROUP_SCHEDULED_PROCESS_P3C1_PRODUCTION | Large | Used for processing |
| (Paid 3 Complex 1) | | | complex contact groups but |
| | | | user has between 5-10M |
| | | | contacts |
| P4C1 | GROUP_SCHEDULED_PROCESS_P4C1_PRODUCTION | X-Large | Used for processing |
| (Paid 4 Complex 1) | | | complex contact groups but |
| | | | user has over 10M contacts |
| O4C1 | GROUP_SCHEDULED_PROCESS_O4C1_PRODUCTION | 2X-Large | Used for specific user |
| (Override) | | | overrides, can be replicated |
| | | | for multiple large scale users |
| FA1 | GROUP_PROCESS_ADHOC_FA1_PRODUCTION | X-Small | Used for processing newly |
| (Free Adhoc 1) | | | created or updated contact |
| | | | groups for free tier |
| | | | customers |
| PA1 | GROUP_PROCESS_ADHOC_PA1_PRODUCTION | X-Small | Used for processing newly |
| (Paid Adhoc 1) | | | created or updated contact |
| | | | groups for most customers |
| PA4 | GROUP_PROCESS_ADHOC_PA4_PRODUCTION | Large | Used for processing newly |
| (Paid Adhoc 4) | | | created or updated contact |
| | | | groups for large customers |

As shown in FIG. 5, a cache 508 is maintained to store for each customer, a total count of contact records. Additionally, after each contact grouping query is processed, the query execution runtime for that contact grouping query is cached. A certain number of prior or historical runtimes for each contact grouping query may be kept in the cache 508. For example, with some embodiments, the last five execution runtimes for a contact grouping query may be stored in the cache. Based on the historical query execution runtimes, an average contact grouping query execution runtime may be derived and stored in the cache.

As shown in FIG. 5, each contact grouping query is allocated to one of the several data pipelines, based on the scheme set forth in the tables above. Over time, as performance of the contact grouping query execution tasks are monitored, the warehouse sizes associated with the data pipelines may be adjusted, or additional pipelines at one or more tiers may be added as needed to accommodate large contact uploads or maintain the SLO (e.g., of one hour) for processing all contact grouping queries. If the processing execution runtime for a contact grouping query consistently gets close to the time interval specified in the SLO, a data pipeline may be replicated to balance the load. Additional warehouses can be spun up when specific contact grouping queries need to be processed in isolation. In some scenarios, another pipeline/warehouse for a tier may be spun up if the number of current pipelines for that tier cannot complete all of the contact grouping query processing for that tier within a certain time.

With some embodiments, the average contact grouping query execution runtime of a contact grouping query may be used to allocate the contact grouping query to one of the several data pipelines 502. For instance, in some cases, a contact grouping query may override its default allocation to a data pipeline, based in part on its historical execution runtime or average execution runtime exceeding some threshold for the data pipeline to which the contact grouping query is allocated by default.

### Machine Architecture

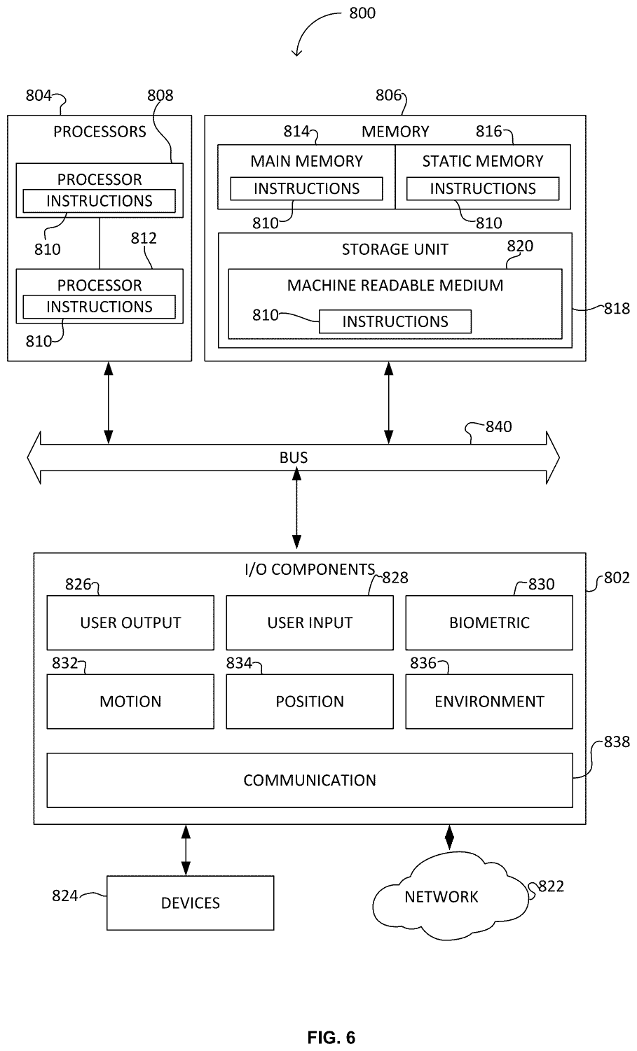

FIG. 6 is a diagrammatic representation of a machine 800—sometimes referred to as a computing device-within which instructions 810 (e.g., software, a program, an application or app, or other executable code) for causing the machine 800 to perform any one or more of the methodologies discussed herein may be executed. For example, the instructions 810 may cause the machine 800 to execute any one or more of the methods described herein. The instructions 810 transform the general, non-programmed machine 800 into a particular machine 800 programmed to carry out the described and illustrated functions in the manner described. The machine 800 may operate as a standalone device or may be coupled (e.g., networked) to other machines. In a networked deployment, the machine 800 may operate in the capacity of a server machine or a client machine (e.g., client computing device) in a server-client network environment, or as a peer machine in a peer-to-peer (or distributed) network environment. The machine 800 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 810, sequentially or otherwise, that specify actions to be taken by the machine 800. Further, while a single machine 800 is illustrated, the term “machine” shall also be taken to include a collection of machines that individually or jointly execute the instructions 810 to perform any one or more of the methodologies discussed herein. The machine 800, for example, may comprise the client machine(s) 310 or any one of multiple server devices forming part of the customer data platform 300. In some examples, the machine 800 may also comprise both client and server systems, with certain operations of a particular method or algorithm being performed on the server-side and with certain operations of the particular method or algorithm being performed on the client-side.

The machine 800 may include processors 804, memory 806, and input/output I/O components 802, which may be configured to communicate with each other via a bus 840. In an example, the processors 804 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 808 and a processor 812 that execute the instructions 810. The term “processor” is intended to include multi-core processors that may comprise two or more independent processors (sometimes referred to as “cores”) that may execute instructions contemporaneously. Although FIG. 8 shows multiple processors 804, the machine 800 may include a single processor with a single-core, a single processor with multiple cores (e.g., a multi-core processor), multiple processors with a single core, multiple processors with multiples cores, or any combination thereof.

The memory 806 includes a main memory 814, a static memory 816, and a storage unit 818, all accessible to the processors 804 via the bus 840. The main memory 806, the static memory 816, and storage unit 818 store the instructions 810 embodying any one or more of the methodologies or functions described herein. The instructions 810 may also reside, completely or partially, within the main memory 814, within the static memory 816, within machine-readable medium 820 within the storage unit 818, within at least one of the processors 804 (e.g., within the processor's cache memory), or any suitable combination thereof, during execution thereof by the machine 800.

The I/O components 802 may include a wide variety of components to receive input, provide output, produce output, transmit information, exchange information, capture measurements, and so on. The specific I/O components 802 that are included in a particular machine will depend on the type of machine. For example, portable machines such as mobile phones may include a touch input device or other such input mechanisms, while a headless server machine will likely not include such a touch input device. It will be appreciated that the I/O components 802 may include many other components that are not shown in FIG. 8. In various examples, the I/O components 802 may include user output components 826 and user input components 828. The user output components 826 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 828 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 802 may include biometric components 830, motion components 832, environmental components 836, or position components 834, among a wide array of other components. For example, the biometric components 830 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 832 include acceleration sensor components (e.g., accelerometer), gravitation sensor components, rotation sensor components (e.g., gyroscope).

The environmental components 836 include, for example, one or more image sensors or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 834 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 802 further include communication components 838 operable to couple the machine 800 to a network 822 or devices 824 via respective coupling or connections. For example, the communication components 838 may include a network interface component or another suitable device to interface with the network 822. In further examples, the communication components 838 may include wired communication components, wireless communication components, cellular communication components, Near Field Communication (NFC) components, Bluetooth® components (e.g., Bluetooth® Low Energy), Wi-FiR components, and other communication components to provide communication via other modalities. The devices 824 may be another machine or any of a wide variety of peripheral devices (e.g., a peripheral device coupled via a USB).

Moreover, the communication components 838 may detect identifiers or include components operable to detect identifiers. For example, the communication components 838 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 838, such as location via Internet Protocol (IP) geolocation, location via Wi-Fi® signal triangulation, location via detecting an NFC beacon signal that may indicate a particular location, and so forth.

The various memories (e.g., main memory 814, static memory 816, and memory of the processors 804) and storage unit 818 may store one or more sets of instructions and data structures (e.g., software) embodying or used by any one or more of the methodologies or functions described herein. These instructions (e.g., the instructions 810), when executed by processors 804, cause various operations to implement the disclosed examples.

The instructions 810 may be transmitted or received over the network 822, using a transmission medium, via a network interface device (e.g., a network interface component included in the communication components 838) and using any one of several well-known transfer protocols (e.g., hypertext transfer protocol (HTTP)). Similarly, the instructions 810 may be transmitted or received using a transmission medium via a coupling (e.g., a peer-to-peer coupling) to the devices 824.

### Software Architecture

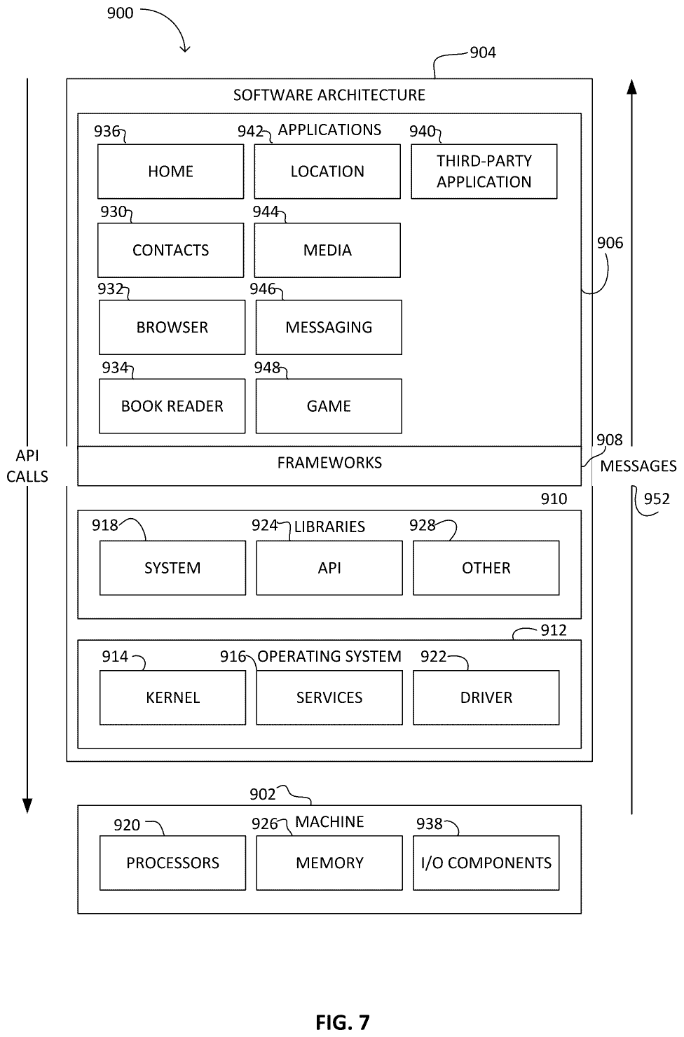

FIG. 7 is a block diagram 900 illustrating a software architecture 904, which can be installed on any one or more of the computing devices described herein. The software architecture 904 is supported by hardware such as a machine 902 that includes processors 920, memory 926, and I/O components 938. In this example, the software architecture 904 can be conceptualized as a stack of layers, where each layer provides a particular functionality. The software architecture 904 includes layers such as an operating system 912, libraries 910, frameworks 908, and applications 906. Operationally, the applications 906 invoke API calls 950 through the software stack and receive messages 952 in response to the API calls 950.

The operating system 912 manages hardware resources and provides common services. The operating system 912 includes, for example, a kernel 914, services 916, and drivers 922. The kernel 914 acts as an abstraction layer between the hardware and the other software layers. For example, the kernel 914 provides memory management, processor management (e.g., scheduling), component management, networking, and security settings, among other functionalities. The services 916 can provide other common services for the other software layers. The drivers 922 are responsible for controlling or interfacing with the underlying hardware. For instance, the drivers 922 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 910 provide a common low-level infrastructure used by the applications 906. The libraries 910 can include system libraries 918 (e.g., C standard library) that provide functions such as memory allocation functions, string manipulation functions, mathematic functions, and the like. In addition, the libraries 910 can include API libraries 924 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 910 can also include a wide variety of other libraries 928 to provide many other APIs to the applications 906.

The frameworks 908 provide a common high-level infrastructure that is used by the applications 906. For example, the frameworks 908 provide various graphical user interface (GUI) functions, high-level resource management, and high-level location services. The frameworks 908 can provide a broad spectrum of other APIs that can be used by the applications 906, some of which may be specific to a particular operating system or platform.

In an example, the applications 906 may include a home application 936, a contacts application 930, a browser application 932, a book reader application 934, a location application 942, a media application 944, a messaging application 946, a game application 948, and a broad assortment of other applications such as a third-party application 940. The applications 906 are programs that execute functions defined in the programs. Various programming languages can be employed to create one or more of the applications 906, structured in a variety of manners, such as object-oriented programming languages (e.g., Objective-C, Java, or C++) or procedural programming languages (e.g., C or assembly language). In a specific example, the third-party application 940 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 940 can invoke the API calls 950 provided by the operating system 912 to facilitate functionalities described herein.

1. (canceled)

2. The computer-implemented method of claim 1, wherein a contact grouping query is assigned a query classification of simple, when the contact grouping query does not include a SQL JOIN statement, and a contact grouping query is assigned a query classification of complex, when the contact grouping query does include a SQL JOIN statement.

3. The computer-implemented method of claim 1, wherein the predetermined size of the virtual data warehouse that the each data pipeline is configured to invoke determines a number of compute resources that the virtual data warehouse service will devote to executing contact grouping queries allocated to the data pipeline.

4. The computer-implemented method of claim 1, further comprising:
subsequent to executing each contact grouping query to update a contact group table, updating a cache with data to indicate a contact grouping query execution runtime for the contact grouping query.

5. The computer-implemented method of claim 4, further comprising:
for a first contact grouping query, calculating an average contact grouping query execution runtime for a predetermined number of prior contact grouping query executions of the first contact grouping query; and
updating a cache to indicate the average contact grouping query execution runtime for the predetermined number of prior contact grouping query executions of the first contact grouping query.

6. The computer-implemented method of claim 5, further comprising:
calculating an expected total execution runtime, for all contact grouping queries allocated to a specific data pipeline in the plurality of data pipelines, using for the calculation the average contact grouping query execution runtime for each contact grouping query;
comparing the expected total execution runtime for all contact grouping queries allocated to the specific data pipeline to a time interval indicated in a service level objective; and
adding a new data pipeline configured to invoke a virtual data warehouse that is the same fixed size as the virtual data warehouse that the specific data pipeline is configured to invoke.

7. The computer-implemented method of claim 1, further comprising:
subsequent to executing a first contact grouping query to update a first contact group table, updating a cache with data to indicate the count of contact records for the entity associated with the first contact grouping query.

8. (canceled)

9. (canceled)

10. The system of claim 9, wherein a contact grouping query is assigned a query classification of simple, when the contact grouping query does not include a SQL JOIN statement, and a contact grouping query is assigned a query classification of complex, when the contact grouping query does include a SQL JOIN statement.

11. The system of claim 9, wherein the predetermined size of the virtual data warehouse that each data pipeline is configured to invoke determines a number of compute resources that the virtual data warehouse service will devote to executing contact grouping queries allocated to the data pipeline.

12. The system of claim 9, wherein the operations further comprise:
subsequent to executing each contact grouping query to update a contact group table, updating a cache with data to indicate a contact grouping query execution runtime for the contact grouping query.

13. The system of claim 12, wherein the operations further comprise:
for a first contact grouping query, calculating an average contact grouping query execution runtime for a predetermined number of prior contact grouping query executions executions of the first contact grouping query; and
updating a cache to indicate the average contact grouping query execution runtime for the predetermined number of prior contact grouping query executions of the first contact grouping query.

14. The system of claim 13, wherein the operations further comprise:
calculating an expected total execution runtime, for all contact grouping queries allocated to a specific data pipeline in the plurality of data pipelines, using for the calculation the average contact grouping query execution runtime for each contact grouping query;
comparing the expected total execution runtime for all contact grouping queries allocated to the specific data pipeline to a time interval indicated in a service level objective; and
adding a new data pipeline configured to invoke a virtual data warehouse that is the same fixed size as the virtual data warehouse that the specific data pipeline is configured to invoke.

15. The system of claim 9, wherein the operations further comprise:
subsequent to executing a first contact grouping query to update a first contact group table, updating a cache with data to indicate the count of contact records for the entity associated with the first contact grouping query.

16. (canceled)

17. The system of claim 16, wherein a contact grouping query is assigned a contact grouping query classification of simple, when the contact grouping query does not include a SQL JOIN statement, and a contact grouping query is assigned a contact grouping query classification of complex, when the contact grouping query does include a SQL JOIN statement.

18. The system of claim 16, wherein the predetermined size of the virtual data warehouse that the each data pipeline is configured to invoke determines a number of compute resources that the virtual data warehouse service will devote to executing contact grouping queries allocated to the data pipeline.

19. The system of claim 23, further comprising:
subsequent to executing each contact grouping query to update a contact group table, means for updating a cache with data to indicate a contact grouping query execution runtime for the contact grouping query.

20. The system of claim 18, further comprising:
for a first contact grouping query, means for calculating an average contact grouping query execution runtime for a predetermined number of prior contact grouping query executions executions of the first contact grouping query; and
means for updating a cache to indicate the average contact grouping query execution runtime for the predetermined number of prior contact grouping query executions of the first contact grouping query.

21. A computer-implemented method for managing contact grouping queries on a Software-as-a-Service (SaaS) platform, the method comprising:
maintaining a plurality of contact grouping queries for a plurality of entities, each contact grouping query associated with an entity and each contact grouping query, when executed, to update contact records for the entity in a contact group table stored in a database of a virtual data warehouse service;
maintaining a plurality of data processing pipelines, each data processing pipeline to invoke, via the cloud-based virtual data warehouse service and according to a predefined schedule, a virtual data warehouse of a predetermined size to execute contact grouping queries to update contact group tables in the database;
maintaining a mapping of contact grouping queries to sizes of virtual data warehouses, the mapping of each contact grouping query to a size of a virtual data warehouse based on a combination of i) a count of contact records for the entity associated with the contact grouping query, and ii) a query classification for the contact grouping query;
assigning the execution of each contact grouping query to a data processing pipeline in the plurality of data processing pipelines based on the mapping; and
according to the predefined schedule, invoking a first virtual data warehouse of a first size and executing a plurality of contact grouping queries allocated to the first data processing pipeline with the first virtual data warehouse to update contact records in contact grouping tables.

22. A system comprising:
a processor for executing computer-readable instructions; and
a memory storage device storing instructions thereon, which, when executed by the processor, cause the system to perform operations comprising:
maintaining a plurality of contact grouping queries for a plurality of entities, each contact grouping query associated with an entity and each contact grouping query, when executed, to update contact records for the entity in a contact group table stored in a database of a virtual data warehouse service;
maintaining a plurality of data processing pipelines, each data processing pipeline to invoke, via the virtual data warehouse service and according to a predefined schedule, a virtual data warehouse of a predetermined size to execute contact grouping queries to update contact group tables in the database;
maintaining a mapping of contact grouping queries to sizes of virtual data warehouses, the mapping of each contact grouping query to a size of a virtual data warehouse based on a combination of i) a count of contact records for the entity associated with the contact grouping query, and ii) a query classification for the contact grouping query;
assigning the execution of each contact grouping query to a data processing pipeline in the plurality of data processing pipelines based on the mapping; and
according to the predefined schedule, invoking a first virtual data warehouse of a first size and executing a plurality of contact grouping queries allocated to the first data processing pipeline with the first virtual data warehouse to update contact records in contact grouping tables.

23. A system comprising:
means for storing a plurality of contact grouping queries for a plurality of entities, each contact grouping query associated with an entity and each contact grouping query, when executed, to update contact records for the entity in a contact group table stored in a database of a virtual data warehouse service;
means for facilitating a plurality of data processing pipelines, each data processing pipeline to invoke, via the virtual data warehouse service and according to a predefined schedule, a virtual data warehouse of a predetermined size to execute contact grouping queries to update contact group tables in the database;
means for mapping of contact grouping queries to sizes of virtual data warehouses, the mapping of each contact grouping query to a size of a virtual data warehouse based on a combination of i) a count of contact records for the entity associated with the contact grouping query, and ii) a query classification for the contact grouping query;
means for assigning the execution of each contact grouping query to a data processing pipeline in the plurality of data processing pipelines based on the mapping; and
means for invoking, according to the predefined schedule, a first virtual data warehouse of a first size and executing a plurality of contact grouping queries allocated to the first data processing pipeline with the first virtual data warehouse to update contact records in contact grouping tables.
